(19) United States
(12) Patent Application Publication
(10) Pub. No.: US 2026/0027872 A1
(43) Pub. Date: Jan. 29, 2026

(54) VENTILATION DUCT APPARATUS FOR AIR CONDITIONING AND A VENTILATION SYSTEM FOR AIR CONDITIONING USING THE SAME

(71) Applicants: HYUNDAI MOTOR COMPANY, Seoul (KR); KIA CORPORATION, Seoul (KR)

(72) Inventor: Man Ju Oh, Hwaseong-si (KR)

(73) Assignees: HYUNDAI MOTOR COMPANY, Seoul (KR); KIA CORPORATION, Seoul (KR)

(21) Appl. No.: 19/018,502

(22) Filed: Jan. 13, 2025

(30) Foreign Application Priority Data
Jul. 29, 2024 (KR) 10-2024-0100346

(51) Int. Cl. B60H 1/34; B60H 1/00

(52) U.S. Cl. CPC B60H 1/3428; B60H 1/00564

(57) ABSTRACT

A ventilation duct apparatus for air conditioning and a ventilation system for air conditioning using the ventilation duct apparatus. In the ventilation duct apparatus, adjustment of a ventilation direction of conditioned air is automated. The ventilation duct apparatus secures the degree of freedom of an external design, since components for adjusting the ventilation direction are provided inside a duct. Not only a function of circulating conditioned air but also a function of diffusing conditioned air is capable of being selectively performed so that a passenger's satisfaction with an interior space air conditioning is increased.

### CROSS REFERENCE TO RELATED APPLICATION

This application claims priority to and the benefit of Korean Patent Application No. 10-2024-0100346, filed Jul. 29, 2024, the entire contents of which are incorporated herein by reference.

### BACKGROUND

### 1. Technical Field

The present disclosure relates to a ventilation duct apparatus for air conditioning and a ventilation system for air conditioning using the ventilation duct apparatus.

### 2. Description of the Related Art

Generally, in a space where a passenger is seated, such as in a vehicle, an air conditioning apparatus is mounted to maintain an appropriate level of interior temperature, humidity, and a quality of interior air. The air conditioning apparatus provides comfort to a driver or the passenger.

The air conditioning apparatus includes a ventilation unit configured to purify external air or internal air and to provide purified air to an interior space of the vehicle. The air condition apparatus further includes an air conditioning unit configured to perform heating by hot air provided to the interior space or to perform cooling by cool air provided to the interior space.

As such, the air conditioning apparatus produces hot air or cool air through operations of the ventilation unit and the air conditioning unit according to a temperature requested by the passenger. The hot air or the cool air is provided to the interior space through an air duct.

In the vehicle, the air duct is provided toward a passenger side of a front seat through a plurality of ventilation nozzle ports mounted in an instrument panel. The air duct is also provided toward a passenger side of a rear seat through a rear duct.

However, a position of the plurality of ventilation nozzle ports is fixed, and a ventilation direction of conditioned air is adjusted by operating a direction regulator that is disposed at the outermost position of the plurality of ventilation nozzle ports.

Accordingly, the air duct in which conditioned air flows simply provides a passage through which the conditioned air is moved. A direction in which the conditioned air is discharged is substantially adjusted by operating the direction regulator, so that the direction regulator is required to be exposed to the passenger's line of sight. In addition, in a conventional air duct, only the degree of the ventilation direction of conditioned air may be changed, and there is also a limitation in the design.

The foregoing is intended merely to aid in the understanding of the background of the present disclosure, and the statements in this section merely provide background information related to the present disclosure and may not constitute prior art.

### SUMMARY

The present disclosure has been made keeping in mind the above problems occurring in the related art. The present disclosure provides a ventilation duct apparatus for air conditioning and a ventilation system for air conditioning using the ventilation duct apparatus capable of automating an adjustment of a ventilation direction of conditioned air. The ventilation duct apparatus secures the degree of freedom of an external design, since components are provided inside a duct for adjusting the ventilation direction. The ventilation duct apparatus is further capable of enhancing a passenger's satisfaction with an interior space air conditioning by providing not only a function of circulating conditioned air but also a function of diffusing conditioned air.

The technical problems to be solved by the present disclosure are not limited to the above-mentioned problems, and other problems which are not mentioned should be clearly understood by those having ordinary skill in the art from the following description.

In order to achieve the objectives described above, the present disclosure provides a ventilation duct apparatus for air conditioning. The ventilation duct apparatus includes a duct that includes an inlet port to which conditioned air from an air conditioner is supplied and an outlet port to which the conditioned air is discharged. The ventilation duct apparatus further includes a first direction switching unit including a first driving part and at least one first flap. The at least one first flap is mounted inside the duct such that the at least one first flap is capable of being tilted in a side direction and being configured such that a tilting position of the at least one first flap is switched by the first driving part, thereby switching a flow direction of the conditioned air into the side direction. The ventilation duct apparatus further includes a second direction switching unit including a second driving part and at least one second flap. The second flap is provided on either an upper side or a lower side of the at least one first flap or on both the upper side and the lower side of the at least one first flap. The second flap is further configured to be curvedly modified or adjusted by the second driving part, thereby switching the flow direction of the conditioned air into a vertical direction.

In one embodiment, a guide surface of the at least one first flap faces the side direction and stands upright so that the at least one first flap may be tilted in the side direction. An upper portion and a lower portion of the at least one first flap facing the at least one second flap may be formed in a concave shape.

The first driving part may include a first actuator and a first driving shaft. The first actuator may be mounted in the duct. The first driving shaft may extend from the first actuator such that the first driving shaft crosses the duct in the side direction and the first driving shaft is connected to the at least one first flap, so that a tilting angle of the at least one first flap may be switched as the first driving shaft is rectilinearly moved in the side direction by an operation of the first actuator.

The first driving part may be mounted at a side of the inlet port of the duct, and the first driving shaft may be connected to a distal end of the at least one first flap at the side of the inlet port such that the first driving shaft is capable of being rotated.

The duct may be provided with a guide shaft that extends such that the guide shaft penetrates a center portion of a guide surface of the at least one first flap.

A penetration slot through which the guide shaft passes may be formed in the at least one first flap. The penetration slot may extend from a center portion of the at least one first flap in a longitudinal direction such that the at least one first flap is tilted only by a preset maximum angle.

In an embodiment, a first mounting part at a side of the inlet port and a second mounting part at a side of the outlet port may be formed inside the duct such that the first mounting part and the second mounting part are spaced apart from each other. Both distal ends of the at least one second flap may be respectively connected to the first mounting part and the second mounting part when a guide surface of the at least one second flap is laid down to face upper and lower surfaces of the duct.

A guide slot may be formed in either the first mounting part or the second mounting part. Any one of end portions of the second flap may be connected to the guide slot such that the end portion of the second flap is capable of being slid. Another one of the end portions of the at least one second flap may be fixed to a remaining one of the first mounting part or the second mounting part.

The guide slot may extend to a length that prevents the end portions of the at least one second flap from being detached even when the at least one second flap is modified by the second driving part.

The second driving part may include a second actuator and a second driving shaft. The second actuator may be mounted in the duct. The second driving shaft may extend from the second actuator such that the second driving shaft crosses the duct in the vertical direction and the second driving shaft is connected to the at least one second flap, such that the at least one second flap may be curvedly modified as the second driving shaft is rectilinearly moved in the vertical direction by an operation of the second actuator.

The second driving shaft may be connected to a center portion of the at least one second flap.

A recessed part may be formed in a portion of the duct facing a guide surface of the at least one second flap.

The present disclosure also provides a ventilation system for air conditioning using the ventilation duct apparatus for air conditioning. In one embodiment, the ventilation system includes a ventilation duct configured to be rotated in a vertical direction by a duct driving part in front of a passenger. The ventilation duct includes an inlet port to which conditioned air is supplied and an outlet port to which the conditioned air is discharged. The ventilation duct further includes a first direction switching unit which includes a first flap that is configured to be tilted in a side direction according to an operation of a first driving part and to switch a flow direction of conditioned air into the side direction. The ventilation duct further includes a second direction switching unit provided on either an upper side or a lower side of the first flap or on both the upper and lower sides of the first flap. The second direction switching unit is configured to switch the flow direction of the conditioned air into the vertical direction by being curvedly modified according to an operation of a second driving part. The ventilation system further includes a diffusing duct provided to match with the outlet port of the ventilation duct when the ventilation duct is moved downward. The diffusing duct is configured to switch a flow direction of the conditioned air discharged through the outlet port of the ventilation duct and to discharge the conditioned air into a direction where the conditioned air is diffused.

A passage part configured to be modified may be provided at the inlet port of the ventilation duct, and the passage part may be connected to a flow path of an air conditioner, thereby receiving the conditioned air.

The diffusing duct may include an inlet part that matches with the outlet port of the ventilation duct when the ventilation duct is moved downward, an outlet part which is open upward and has a diffusing part, and end portions of the diffusing duct connecting the inlet part and the outlet part to each other that may be curvedly formed.

The ventilation system may further include a screen disposed to be spaced apart from a side of the outlet port of the ventilation duct. The screen may be configured to be moved in the vertical direction or stored by a screen driving part.

The ventilation duct and the screen may be disposed in front of the passenger, and the screen may be disposed between the ventilation duct and the passenger.

The ventilation system may further include a controller configured to control the duct driving part and the screen driving part for each mode, thereby adjusting a rotation position of the ventilation duct and a deployment or a storage of the screen.

In a first ventilation mode, the controller may be configured to control the duct driving part and the screen driving part such that the ventilation duct is rotated to a position set by a user or a preset position and the screen is moved to a position lower than the outlet port of the ventilation duct.

In a second ventilation mode, the controller may be configured to control the duct driving part and the screen driving part such that the ventilation duct is moved maximally upward and the screen is moved maximally upward.

In a diffusing mode, the controller may be configured to control the duct driving part and the screen driving part such that the ventilation duct is moved to be stored so that conditioned air is discharged through the diffusing duct and the screen is moved to a preset position according to the diffusing mode.

In the ventilation duct apparatus for air conditioning and the ventilation system for air conditioning using the ventilation duct apparatus described above, the adjustment of the ventilation direction of conditioned air is automated, the degree of freedom of external design is secured since components for adjusting the ventilation direction are provided inside the duct, and the passenger's satisfaction with the interior space air conditioning is increased since not only the function of circulating conditioned air but also the function of diffusing conditioned air is selectively performed.

The effects that can be obtained from the present disclosure are not limited to the above-mentioned effects, and other effects not mentioned herein should be clearly understood by those having ordinary skill in the art from the following description.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a view illustrating a ventilation duct apparatus for air conditioning according to an embodiment of the present disclosure;

FIG. 2 is a side cross-sectional view illustrating the ventilation duct apparatus for air conditioning illustrated in FIG. 1;

FIG. 3 is a view illustrating a first direction switching unit of the ventilation duct apparatus for air conditioning illustrated in FIG. 1;

FIG. 4 is a view illustrating a basic position ventilation of the first direction switching unit according to an embodiment of the present disclosure;

FIG. 5 is a view illustrating a right side ventilation of the first direction switching unit according to an embodiment of the present disclosure;

FIG. 6 is a view illustrating a left side ventilation of the first direction switching unit according to an embodiment of the present disclosure;

FIG. 7 is a view illustrating a basic position ventilation of a second direction switching unit according to an embodiment of the present disclosure;

FIG. 8 is a view illustrating an upper side ventilation of the second direction switching unit according to an embodiment of the present disclosure;

FIG. 9 is a view illustrating a lower side ventilation of the second direction switching unit according to an embodiment of the present disclosure;

FIG. 10 is a view illustrating a ventilation system for air conditioning using the ventilation duct apparatus for air conditioning of the present disclosure;

FIG. 11 is a view illustrating a first ventilation mode in the ventilation system for air conditioning illustrated in FIG. 10;

FIG. 12 is a view illustrating a second ventilation mode in the ventilation system for air conditioning illustrated in FIG. 10; and

FIG. 13 is a view illustrating a diffusing mode in the ventilation system for air conditioning illustrated in FIG. 10.

### DETAILED DESCRIPTION

Detailed description of known technologies should be omitted if it is determined that the detailed description of the known technologies obscures the embodiments of the present specification. In addition, the accompanying drawings are merely intended to easily describe the embodiments of the present specification, but the spirit and technical scope of the present specification is not limited by the accompanying drawings. It should be understood that the present specification is not limited to specific disclosed embodiments, but includes all modifications, equivalents and substitutes included within the spirit and technical scope of the present disclosure.

Terms including ordinals such as “first” or “second” used herein may be used to describe various elements, but the elements are not limited by the terms. The terms are used only for the purpose of distinguishing one constituent element from another constituent element.

As used herein, the singular forms “a”, “an”, and “the” are intended to include the plural forms as well, unless the context clearly indicates otherwise.

It is to be understood that terms such as “including”, “having”, or the like are intended to indicate the existence of the features, numbers, steps, actions, elements, components, or combinations thereof disclosed in the specification, and are not intended to preclude the possibility that one or more other features, numbers, steps, actions, elements, components, or combinations thereof may exist or may be added.

In the following description, the expressions “module” and “part” contained in terms of constituent elements to be described are selected or used together in consideration only of the convenience of writing the following specification, and the expressions “module” and “part” do not necessarily have different meanings or roles.

When a component is referred to as being “connected” or “contacted” to another component, it should be understood that it may be directly connected or contacted to the other component, but other components may exist therebetween. On the other hand, when a component is referred to as being “directly connected” or “directly contacted” to another component, it should be understood that there is no other component therebetween.

When a component, device, element, controller, module, or the like (i.e., an apparatus) of the present disclosure is described as having a purpose or performing an operation, function, or the like, the component, device, element, controller, module, or the like should be considered herein as being “configured to” meet that purpose or to perform that operation or function. Each component, device, element, controller, module, or the like may separately embody or be included with a processor and a memory, such as a non-transitory computer readable media, as part of such an apparatus.

A mobility device may refer to a device or vehicle configured to move through spaces such as land, underground, air, space, sea, and/or underwater. In one embodiment, a mobility device on the ground or underground may be disposed in the form of, for example, a vehicle, a robot, or the like. In another embodiment, a mobility device in the air or space may relate to aerial mobility, and may be disposed in the form of, for example, a general fixed-wing or rotary-wing aircraft, an advanced air mobility (AAM) device which has been actively developed recently, a means of transportation mounted on an unmanned aerial vehicle, a drone, a rocket, and a satellite, or the like. In another embodiment, a mobility device at sea or underwater may be implemented as, for example, a ship, a submarine, or the like. The mobility device may not be limited to a specific space and may be implemented as a mobile body moving the above-mentioned spaces (i.e., a mobile body which may move between multiple spaces), and may be implemented as, for example, an amphibious vehicle, or a flying vehicle.

In addition, “unit” or “control unit” included in the names of the motor control unit (MCU) and the hybrid control unit (HCU) generally refer to a controller that controls a specific function of the vehicle and do not mean a generic function unit.

In addition, “controller” may include a communication device configured to communicate with another controller or a sensor in order to control a function assigned thereto, a memory configured to store an operating system, logic commands, and input and output information, and at least one processor configured to perform determination, calculation, and decision necessary to control the assigned function.

Hereinafter, embodiments disclosed in the present specification are described in detail with reference to the accompanying drawings. In the present specification, the same or similar components are denoted by the same or similar reference numerals, and a repeated description thereof are omitted.

A ventilation duct apparatus for air conditioning may be applied to a vehicle. The ventilation duct apparatus for air conditioning may be provided in various types of mobility devices in which a passenger enters or may be provided in an interior space of a building.

In the ventilation duct apparatus for air conditioning, a first direction switching unit 200 and a second direction switching unit 300 are provided inside a duct 100. The degree of freedom of an external design of the ventilation duct apparatus may be secured since the first direction switching unit 200 and the second direction switching unit 300 are provided inside the duct 100 and are not exposed to the outside.

The first direction switching unit 200 and the second direction switching unit 300 may adjust a ventilation direction of conditioned air by being automated. A flow direction of the conditioned air may be switched by adjusting an angle of a flap for adjusting the ventilation direction or by modifying the flap.

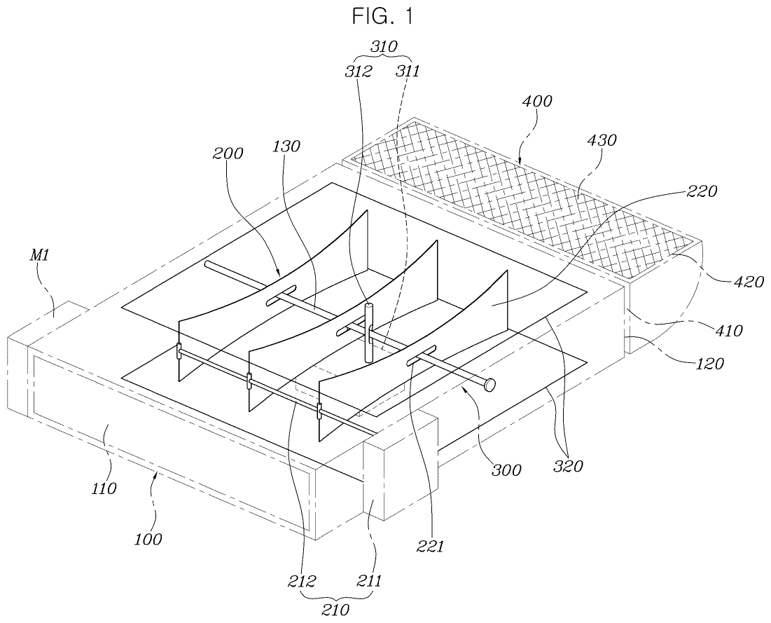

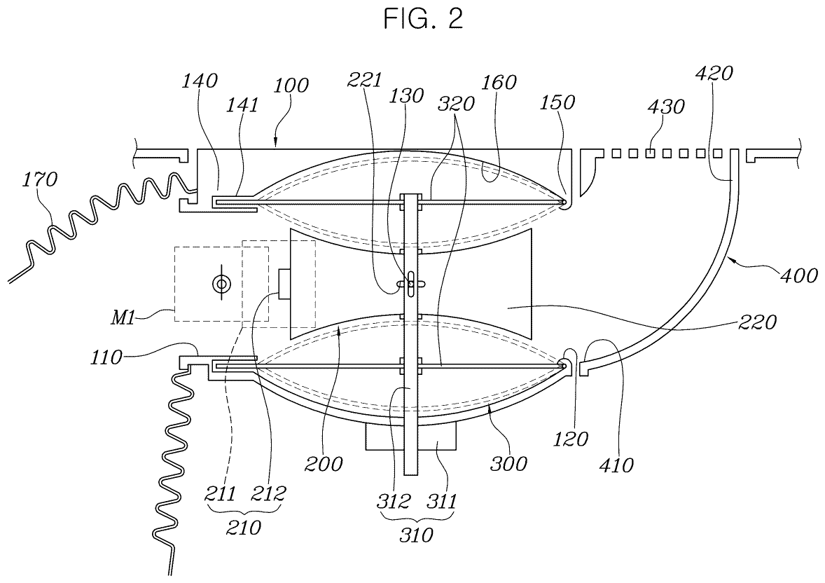

As illustrated in FIG. 1 and FIG. 2, the ventilation duct apparatus for air conditioning includes the duct 100 that includes an inlet port 110 to which conditioned air from an air conditioner H is supplied and an outlet port 120 to which the conditioned air is discharged. The first direction switching unit 200 includes a first driving part 210 and at least one first flap 220. The first flap 220 is mounted inside the duct 100 such that the first flap 220 is capable of being tilted in a side direction. The first flap 220 is further configured such that a tilting position of the first flap 220 may be switched by the first driving part 210, thereby switching a flow direction of the conditioned air to the side direction. The second direction switching unit 300 includes a second driving part 310 and at least one second flap 320. The second flap 320 is provided on either an upper side or a lower side of the first flap 220 or on both the upper and lower sides of the first flap 220. The second flap 320 is configured to be curvedly modified by the second driving part 310, thereby switching the flow direction of the conditioned air to a vertical direction.

The duct 100 may be applied to a position around the passenger where the conditioned air may be transferred to the passenger. Such a duct 100 may be mounted on a crash pad when the duct is applied to a vehicle.

The duct 100 is provided with the inlet port 110 and the outlet port 120. The inlet port 110 is configured to receive the conditioned air from the air conditioner H. The outlet port 120 is formed such that the conditioned air is discharged to the outlet port 120. The ventilation direction of the conditioned air is determined by the first direction switching unit 200 and the second direction switching unit 300.

The first direction switching unit 200 includes the first driving part 210 and the first flap 220. The first flap 220 may be formed in a flat plate shape, may be provided as a plurality of flaps 220, and may be disposed to stand upright.

The first driving part 210 may be mounted outside the duct 100 and may be configured to provide a driving force for changing a position of the first flap 220. A direction of the driving force provided from the first driving part 210 may be a direction in which the first flap 220 is tilted in the side direction. The side direction may be an orthogonal direction, i.e., a horizontal direction, on a path between the inlet port 110 and the outlet port 120 with reference to FIG. 1. The side direction may further be a left-right direction.

Through this, the first direction switching unit 200 may change the flow direction of the conditioned air to the side direction by switching the tilting position of the first flap 220 by the first driving part 210.

The second direction switching unit 300 includes the second driving part 310 and the second flap 320. The second flap 320 may be formed in a flat plate shape. The second flap 320 may be elastically modified, may be provided as a plurality of second flaps 320, and may be disposed to stand upright. In addition, the second flap 320 may be disposed at any one of the upper side and the lower side of the first flap 220. In the present disclosure, the second flap 320 is disposed at both the upper and lower sides of the first flap 220 to switch the flow direction of the conditioned air to a wide range.

The second driving part 310 may be mounted outside the duct 100, and may be connected to the second flap 320. The second driving part 310 is configured to provide a driving force for modifying the second flap 320. A direction of the driving force provided from the second driving part 310 is a vertical direction, and the second driving part 310 is configured to modify the second flap 320 so that the second flap 320 is modified in the vertical direction.

Thus, as the second flap 320 receives a force in the vertical direction by the second driving part 310 and the second flap 320 is curvedly modified, the flow direction of the conditioned air that flows inside the duct 100 is guided along the curved shape of the second flap 320, so that a discharge direction may be switched to the upward or downward.

Thus, in the present disclosure, the discharge direction of the conditioned air may be adjusted through the first direction switching unit 200 and the second direction switching unit 300 provided inside the duct 100.

Particularly, in the first flap 220, as the tilting position of the first flap 220 is changed, the flow direction of the conditioned air may be switched to the side direction. In the second flap 320, as the curved shape of the second flap 320 in the vertical direction is modified, the flow direction of the conditioned air may be switched to the vertical direction.

In an embodiment, as illustrated in FIG. 2, the first flap 220 may be disposed such that a guide surface of the first flap 220 faces the side direction and the first flap 220 may be tilted in the side direction. The first flap 220 may be formed such that upper and lower portions of the first flap 220 facing the second flaps 320 are concave.

For example, the first flap 220 may be formed in a flat plate shape, and the flat surface of the first flap 220 may be the guide surface.

Such a first flap 220 is disposed such that the guide surface faces the side direction and the first flap 220 may be tilted in the side direction, so that the flow direction of the conditioned air that moves along the guide surface may be switched according to a tilting angle in the side direction.

In addition, the first flap 220 is formed such that a portion of the first flap 220 facing the second flap 320 is concave. In the present disclosure, since the second flap 320 is disposed on both the upper and lower sides of the first flap 220, both the upper and lower portions of the first flap 220 may be concave.

As such, since the upper and lower portions of the first flap 220 are concave, there is no interference between the second flap 320 and the first flap 220 even when the second flap 320 is curvedly modified in the shape that protrudes towards the first flap 220. The concave upper and lower portions of the first flap 220 are concave only to a portion that interferes with the second flap 320 when the second flap 320 is curvedly modified, so that guiding of the conditioned air through the guide surface of the first flap 220 may be performed smoothly.

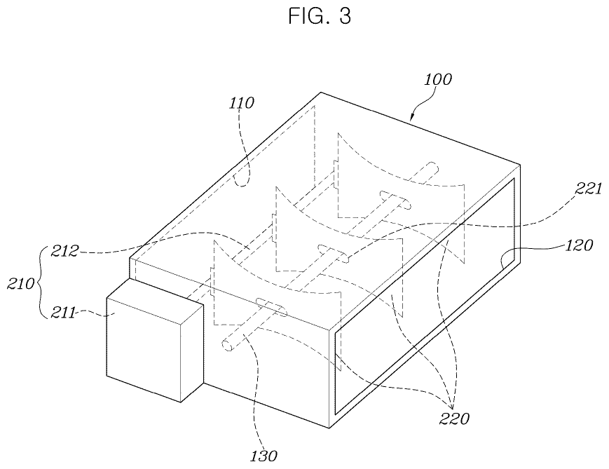

Meanwhile, as illustrated in FIG. 1 and FIG. 3, the first driving part 210 includes a first actuator 211 and a first driving shaft 212.

The first actuator 211 may be mounted on an outer side surface of the duct 100. The first driving shaft 212 may be connected to the first actuator 211. The first actuator 211 may be configured to provide a driving force so that the first driving shaft 212 is moved in the side direction of the duct 100.

The first driving shaft 212 is connected to the first actuator 211, and the first driving shaft 212 extends to cross the duct 100 in the side direction. Furthermore, as the first flap 220 is connected to the first driving shaft 212, the tilting angle of the first flap 220 may be switched when the first driving shaft 212 is rectilinearly moved in the side direction by the operation of the first actuator 211.

In an embodiment, the plurality of first flaps 220 may be provided and may be connected to the first driving shaft 212 by being spaced apart from each other by a predetermined distance, so that the plurality of first flaps 220 may be tilted in the same angle. The first driving shaft 212 and the first flap 220 may be connected to each other as a hinge structure. In addition to the hinge structure, various connection structures may be applied to the first driving shaft 212 as a connection structure, where the first flap 220 may be tilted in conjunction with the rectilinear movement of the first driving shaft 212.

Specifically, the first driving part 210 is mounted on the side of the inlet port 110 of the duct 100. The first driving shaft 212 may be connected to a distal end of the first flap 220 at the side of the inlet port 110 such that the first driving shaft 212 may be rotated.

As such, since the first driving part 210 is mounted on the side of the inlet port 110 of the duct 100, the first driving shaft 212 connected to the first driving part 210 may be connected to the first flap 220 to which the conditioned air is introduced. If the first driving shaft 212 is connected to a side of the first flap 220 to which the conditioned air is discharged, the conditioned air that flows by being guided by the first flap 220 may interfere with the first driving shaft 212, so that an interference in the flow of the conditioned air may occur.

Therefore, the first driving shaft 212 is connected to the distal end of the first flap 220 at the side of the inlet port 110, so that a decrease is prevented in the flowability of the conditioned air flowing through the guide surface of the first flap 220.

In addition, since the first driving shaft 212 is connected to the distal end of the first flap 220, a tilting angle amount of the first flap 220 that is tilted in connection with the rectilinear movement of the first driving shaft 212 may be secured. As a result, a tilting angle range of the first flap 220 may be secured while a movement amount of the first driving shaft 212 is reduced.

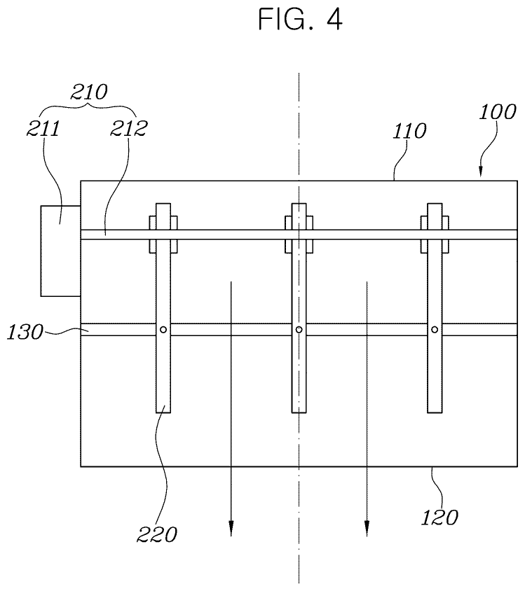

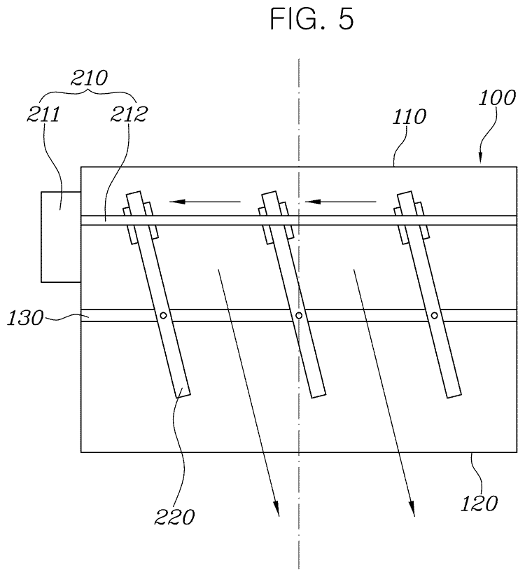

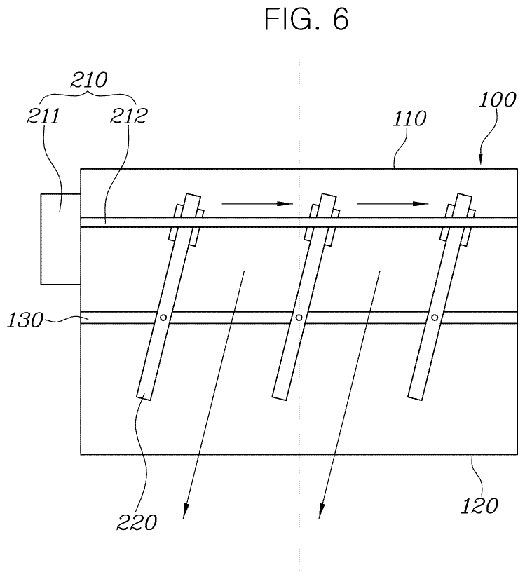

For example, as illustrated in FIG. 4, in an operation of the first direction switching unit 200, the conditioned air is directly discharged toward the outlet port 120 in an initial position in which the first flap 220 is disposed. The initial position may be where the first flap 220 faces the outlet port 120 of the duct 100. Here, as illustrated in FIG. 5, when the first driving shaft 212 is moved to the left side with reference to the drawing, the first flap 220 is tilted, and an end portion of the first flap 220 at a side of the outlet port is moved to the right side with reference to the drawing. Therefore, as the conditioned air flows along the guide surface of the first flap 220 and the flow direction is switched, the conditioned air may be discharged in the right direction through the outlet port 120 of the duct 100. FIG. 6 is a view illustrating that the conditioned air is discharged in the left direction due to the first driving part 210 that is driven in a direction opposite to the first driving part 210 in FIG. 5.

Meanwhile, as illustrated in FIG. 1 to FIG. 3, the duct 100 may be provided with a guide shaft 130 that extends through a center portion of the guide surface of the first flap 220.

The guide shaft 130 is fixed inside the duct 100 and extends such that the guide shaft 130 crosses the inside of the duct 100 in the side direction. Accordingly, when the plurality of first flaps 220 is provided, the guide shaft 130 penetrates each of the first flaps 220. Furthermore, as the guide shaft 130 penetrates each center portion of each of the first flaps 220, the first flaps 220 may be tilted around the guide shaft 130. In addition, the position of the first flap 220 may be fixed inside the duct 100 as the guide shaft 130 penetrates the first flap 220.

Specifically, a penetration slot 221 through which the guide shaft 130 passes is formed in the first flap 220, and the penetration slot 221 may extend in a longitudinal direction from the center portion of the first flap 220 such that the first flap 220 may be tilted only by a preset maximum angle.

As illustrated in FIG. 2, the penetration slot 221 is formed in the center portion of the first flap 220, and the guide shaft 130 is connected to the first flap 220 by penetrating the penetration slot 221.

Particularly, since the penetration slot 221 is formed such that the penetration slot 221 extends along the longitudinal direction in the first flap 220, interference with the guide shaft 130 may be avoided when the first flap 220 is tilted. For example, when the first flap 220 is tilted, interference with the guide shaft 130 is avoided as much as the penetration slot 221 is extended, so that a tilting operation of the first flap 220 may be performed smoothly. Furthermore, since tilting of the first flap 220 is allowed only by the extended length of the penetration slot 221, excessive tilting of the first flap 220 may be limited.

As such, in the first direction switching unit 200, the tilting position of the first flap 220 is switched by the first driving part 210, and the first flap 220 is rotated with respect to the guide shaft 130. The first flap 220 may be stably positioned inside the duct 100 as the guide shaft 130 penetrates the penetration slot 221 of the first flap 220. In addition, the tilting angle of the first flap 220 is switched in connection with the rectilinear movement of the first driving shaft 212 connected to the first flap 220, so that the flow direction of the conditioned air may be switched to the side direction.

Meanwhile, the second driving part 310 includes a second actuator 311 and a second driving shaft 312.

The second actuator 311 may be mounted on an outer upper surface of the duct 100 or an outer lower surface of the duct 100. The second driving shaft 312 is connected to the second actuator 311. The second actuator 311 is configured to provide a driving force to the second driving shaft 312 such that the second driving shaft 312 is moved in the vertical direction of the duct 100.

The second driving shaft 312 is connected to the second actuator 311, the second driving shaft 312 extends such that the second driving shaft crosses the duct 100 in the vertical direction, and the second flap 320 is connected to the second driving shaft 312. Therefore, the second flap 320 is curvedly modified in the vertical direction as the second driving shaft 312 is rectilinearly moved in the vertical direction by an operation of the second actuator 311.

In addition, a hole through which the guide shaft 130 described above passes may be formed in the second driving shaft 312. The guide shaft 130 may be disposed such that the guide shaft 130 passes through the second driving shaft 312 so as to avoid interference between the second driving shaft 312 and the guide shaft 130. The second driving shaft 312 and the guide shaft 130 may be disposed such that the second driving shaft 312 and the guide shaft 130 cross each other and are spaced apart from each other. The second driving shaft 312 and the guide shaft 130 may further be configured such that the second driving shaft 312 and the guide shaft 130 do not interfere with each other in a mutual operation relationship.

In an embodiment, the second flap 320 may be provided such that respective second flaps 320 are provided on the upper and lower sides of the first flap 220. The second driving shaft 312 may be connected to the plurality of second flaps 320 such that the second flaps 320 are modified in the same shape.

In addition, the second driving shaft 312 may be connected to a center portion of the second flap 320. In an embodiment, the second flap 320 may be formed in a flat plate shape, and the second driving shaft 312 may be connected to the center portion of the second flap 320. Therefore, when the second driving shaft 312 performs a rectilinear movement, the second flap 320 may be modified in a balanced curved shape from the second driving shaft 312. In addition, when the second driving shaft 312 is connected to the center portion of the second flap 320, the modification amount of the second flap 320 may be maximally secured. Through this, a flow direction switching range of the conditioned air as the second flap 320 is modified into the curved shape may be secured.

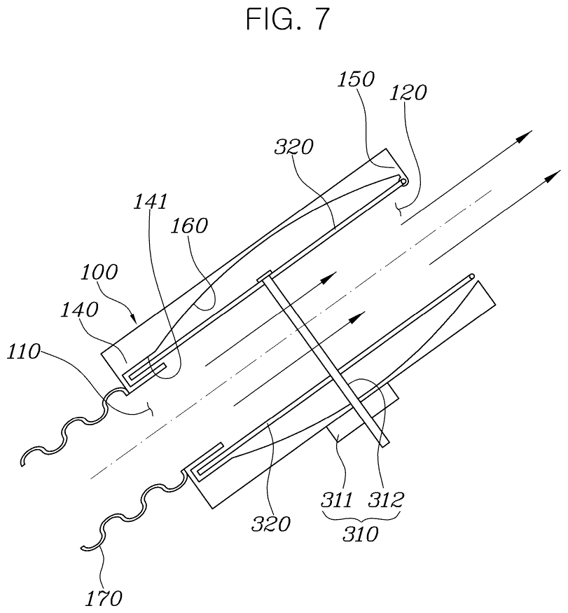

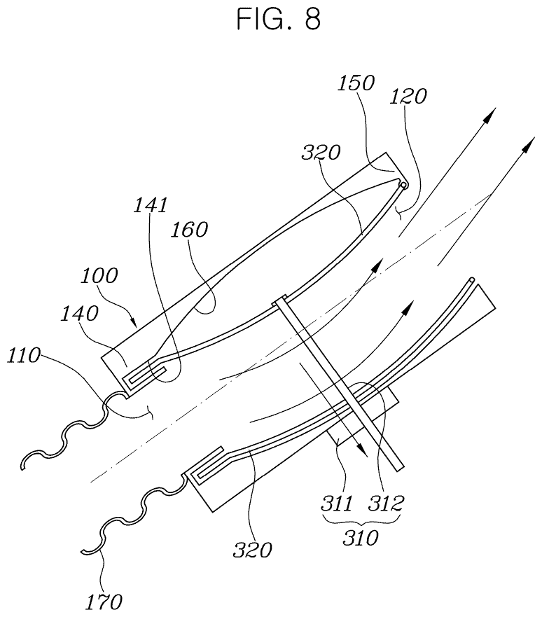

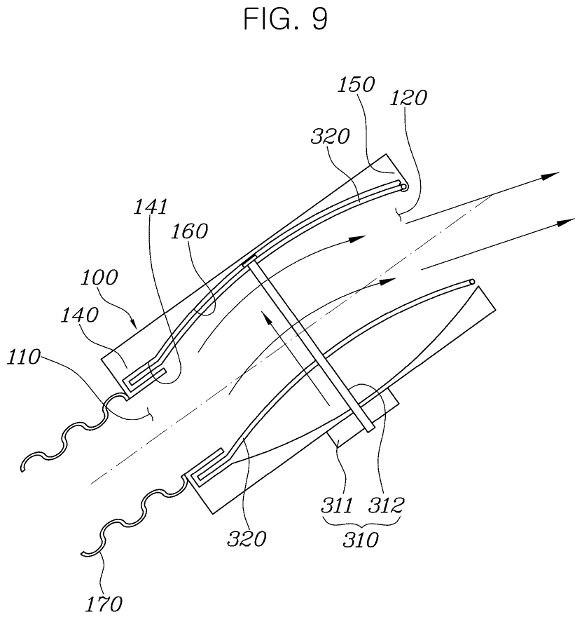

Accordingly, as illustrated in FIG. 7, in an initial position in which the second flap 320 is unbent, the conditioned air is directly discharged toward the outlet port 120. Here, as illustrated in FIG. 8, when the second driving shaft 312 is moved downward with reference to the drawing, the second flap 320 is modified such that the second flap 320 is curved along a movement direction of the second driving shaft 312. Therefore, the conditioned air introduced into the inlet port 110 of the duct 100 flows downward along the curved shaft of the second flap 320 and then flows upward, so that the conditioned air may be discharged upward through the outlet port 120 of the duct 100. FIG. 9 is a view illustrating that the conditioned air is discharged in the downward direction due to the second driving part 310 that is driven in a direction opposite to the second driving part 310 in FIG. 8.

Meanwhile, as illustrated in FIG. 2, a first mounting part 140 at a side of the inlet port 110 and a second mounting part 150 at a side of the outlet port 120 are formed inside the duct 100 such that the first mounting part 140 and the second mounting part 150 are spaced apart from each other. Both distal ends of the second flap 320 may be connected to the first mounting part 140 and the second mounting part 150 when the second flap 320 is disposed to be laid down with a guide surface of the second flap 320 facing upper and lower surfaces.

In an embodiment, the first mounting part 140 is formed on the side of the inlet port 110, and the second mounting part 150 is formed on the side of the outlet port 120.

Here, the second flap 320 is disposed such that the guide surface faces in the vertical direction. The second flap 320 is connected to the second driving shaft 312 of the second driving part 310 when the both distal ends of the second flap 320 are connected to the first mounting part 140 and the second mounting part 150. Therefore, when the both distal ends of the second flap 320 are fixed to the first mounting part 140 and the second mounting part 150, the second flap 320 may be modified by a moving force of the second driving shaft 312.

Furthermore, a guide slot 141 may be formed in either the first mounting part 140 or the second mounting part 150. Any one end portion of the second flap 320 is coupled to the guide slot 141 such that the second flap 320 may be slid. The remaining end portion of the second flap 320 may be fixed to the remaining one of the first mounting part 140 and the second mounting part 150.

In an embodiment, the guide slot 141 is formed in the first mounting part 140.

In addition, the guide slot 141 may extend to a length that prevents the end portion of the second flap from being detached even if the second flap 320 is modified by the second driving part 310.

Through this, as the second flap 320 is connected to the first mounting part 140 and the second mounting part 150, the position of the second flap 320 is fixed. Furthermore, even when the second flap 320 is curvedly modified by the second driving part 310 and the length of the second flap 320 in the longitudinal direction is reduced, a gap according to the reduction in length of the second flap 320 is offset from the guide slot 141 of the first mounting part 140. The gap is offset such that the second flap 320 is not separated from the first mounting part 140 and the second mounting part 150.

In addition, the second flap 320 is mounted such that one end portion of the second flap 320 is connected to the guide slot 141 of the first mounting part 140. The second flap 320 is further mounted such that the one end portion of the second flap 320 may be moved. The other one end portion of the second flap 320 is fixedly mounted on the second mounting part 150, so that a shape of the second flap 320 modified due to repeated modification by the second driving part 310 may be the same shape. As such, the modified shape of the second flap 320 according to an operation amount of the second driving part 310 may be maintained consistently.

Meanwhile, as illustrated in FIG. 2, a recessed part 160 may be formed in a portion of the duct 100 facing the guide surface of the second flap 320.

The recessed part 160 may be formed at a portion inside the duct 100 facing the second flap 320. In an embodiment, the recessed part 160 may be formed at the second flap 320 in the upper side of the duct 100 and at the second flap 320 in the lower side of the duct 100. The second flaps 320 are provided on the upper and lower sides of the first flap 220.

Such a recessed part 160 may be curvedly formed such that the second flap 320 does not contact the recessed part 160 when the second flap 320 is modified by the second driving part 310. The recessed part 160 may be recessed by a depth that prevents the recessed part 160 from contacting the second flap 320 even when the second flap 320 is modified to a maximum modification range by the second driving part 310.

Referring to FIG. 8 and FIG. 9, when the second flap 320 is curvedly modified by the second driving part 310, the second flap 320 is modified into a space formed by the formation of the recessed part 160, so that the modification range of the second flap 320 is secured, thereby securing the flow direction of the conditioned air through the second flap 320 in a wide range.

As such, in the ventilation duct apparatus for air conditioning, the first direction switching unit 200 and the second direction switching unit 300 are provided inside the duct 100. The first direction switching unit 200 is configured to switch the flow direction of the conditioned air into the side direction, and the second direction switching unit 300 is configured to switch the flow direction of the conditioned air into the vertical direction, so that flow direction of the conditioned air discharged through the outlet port 120 of the duct 100 may be diversified.

In addition, since the first direction switching unit 200 and the second direction switching unit 300 are disposed inside the duct 100, the degree of freedom of an external design is secured, and convenience of use is secured by automating the flow direction switching of the conditioned air. Packaging may be easily performed since the size of the duct 100 is reduced by optimizing the design of each part in the duct 100 having a limited size.

Meanwhile, as illustrated in FIG. 1, a ventilation system for air conditioning includes the ventilation duct 100 configured to be rotated in the vertical direction by a duct driving part M1 in front of the passenger. The ventilation duct 100 includes the inlet port 110 to which conditioned air is supplied and the outlet port 120 to which the conditioned air is discharged. The ventilation duct 100 further includes the first direction switching unit 200 which includes the first flap 220 that is configured to be tilted in the side direction according to the operation of the first driving part 210 and to switch the flow direction of the conditioned air into the side direction. The ventilation duct 100 further includes the second direction switching unit 300 provided on either the upper side or the lower side of the first flap 220 or on both the upper and lower sides of the first flap 220 and configured to switch the flow direction of the conditioned air into the vertical direction by being curvedly modified according to the operation of the second driving part 310. The ventilation system also includes a diffusing duct 400 that matches with the outlet port 120 of the ventilation duct 100 when the ventilation duct 100 is moved downward. The diffusing duct 400 is configured to switch the flow direction of the conditioned air discharged through the outlet port 120 of the ventilation duct 100 and to discharge the conditioned air into a direction where the conditioned air is diffused.

The ventilation duct 100 is mounted such that the ventilation duct 100 may be rotated in the vertical direction, and is connected to the duct driving part M1 such that a rotation position of the ventilation duct 100 may be adjusted. The duct driving part M1 may be formed of a motor, and may be connected to the ventilation duct 100 in a gear connection manner. As the duct driving part M1 rotates the ventilation duct 100, the duct driving part M1 may adjust a supply direction of the conditioned air discharged through the ventilation duct 100.

The duct 100 includes the inlet port 110 and the outlet port 120. The inlet port 110 is configured to receive the conditioned air from the air conditioner H. The outlet port 120 is formed such that the conditioned air is discharged to the outlet port 120. The ventilation direction of the conditioned air is determined by the first direction switching unit 200 and the second direction switching unit 300.

The first direction switching unit 200 includes the first driving part 210 and the first flap 220. The first flap 220 may be formed in a flat plate shape, may be provided as a plurality of flaps 220, and may be disposed to stand upright. As the tilting position of the first flap 220 is changed, the flow direction of the conditioned air is switched into the side direction.

The second direction switching unit 300 includes the second driving part 310 and the second flap 320. The second flap 320 may be formed in a flat plate shape that may be elastically modified, may be provided as a plurality of second flaps 320, and may be disposed to stand upright. As the shape of the second flap 320 curved in the vertical direction is modified, the flow direction of the conditioned air may be switched into the vertical direction.

Meanwhile, the diffusing duct 400 is spaced apart from the ventilation duct 100, and is provided such that the diffusing duct 400 matches with outlet port 120 of the ventilation duct 100 when the ventilation duct 100 is moved downward.

In such a diffusing duct 400, when the ventilation duct is moved downward and is stored, the diffusing duct 400 matches with the outlet port 120 of the ventilation duct 100, and the diffusing duct 400 receives the conditioned air discharged through the outlet port 120 of the ventilation duct 100. The diffusing duct 400 is configured to switch the flow direction of the conditioned air through an internal shape and a shape of a side where the conditioned air is discharged, thereby discharging the conditioned air into a direction where the conditioned air is diffused.

Through this, when the ventilation duct 100 is rotated upward and moved, the discharge direction of the conditioned air may be adjusted in the up and down directions and the left and right directions by the first direction switching unit 200 and the second direction switching unit 300. Furthermore, when the ventilation duct 100 is rotated downward and stored, the conditioned air may be diffused by the diffusing duct 400. As such, the discharge direction of the conditioned air may be variously changed according to the position of the ventilation duct 100, and the conditioned air may be optimized and provided to the passenger according to a required condition and a situation.

Meanwhile, as illustrated in FIG. 2, a passage part 170 capable of being modified may be provided at the inlet port 110 of the ventilation duct 100, the passage part 170 may be connected to a flow path of the air conditioner H, and the passage part 170 may receive the conditioned air.

The passage part 170 may be formed in a shape that is capable of being modified. For example, the passage part 170 may be formed as a bellows-type passage.

Thus, since the passage part 170 is connected to the inlet port 110 of the ventilation duct 100, a connection structure between the ventilation duct 100 and the flow path of the conditioned air may be freely configured. The connection between the air conditioner H and the ventilation duct 100 may be easily realized as the degree of freedom of design is secured.

Meanwhile, the diffusing duct 400 includes an inlet part 410 that matches with the outlet port of the ventilation duct 100 when the ventilation duct 100 is moved downward. The diffusing duct 400 further includes the outlet part 420 which is open upward and which is provided with a diffusing part 430. Furthermore, ends portions of the diffusing duct 400 connecting the inlet part 410 and the outlet part 420 to each other may be curvedly formed.

As illustrated in FIG. 1 and FIG. 2, the diffusing duct 400 is provided with the inlet part 410 into which the conditioned air passing through the ventilation duct 100 is introduced when the outlet port 120 of the ventilation duct 100 matches with the diffusing duct 400. The diffusing duct 400 is further provided with the outlet part 420 to which the conditioned air is discharged.

Here, the diffusing part 430 is provided at the outlet part 420 of the diffusing duct 400, and the diffusing part 430 may be configured as a mesh. Through this, air discharged through the outlet part 420 of the diffusing duct 400 may be discharged such that the air is diffused by the diffusing part 430 formed as the mesh.

In addition, the end portions of the diffusing duct 400 between the inlet part 410 and the outlet part 420 are curved, and the outlet part 420 is open upward. Therefore, the conditioned air passing through the diffusing duct 400 may be discharged upward through the outlet part 420 and may be diffused upward by the diffusing part 430.

As such, the diffusing duct 400 is provided to diffuse and provide the conditioned air to the passenger. When the ventilation duct 100 is moved downward and stored, the conditioned air may be diffused and discharged through the diffusing duct 400.

Meanwhile, a screen 500 may be further provided that is disposed to be spaced apart from the side of the outlet port 120 of the ventilation duct 100 and configured to be moved in the vertical direction or stored by a screen driving part M2.

The screen driving part M2 may be formed of a motor and may be connected to the screen 500 in a rack-and-pinion manner. In the connection structure in which the screen 500 is capable of being moved up and down by the screen driving part M2, various structures other than the rack-and-pinion manner may be applied.

Specifically, the ventilation duct 100 and the screen 500 may be disposed in front of the passenger, and the screen 500 may be disposed between the ventilation duct 100 and the passenger.

The ventilation duct 100 and the screen 500 may be mounted in the crash pad in the interior space. For example, the ventilation duct 100 and the screen 500 may be provided in front of the passenger, and the screen 500 and the ventilation duct 100 may be sequentially disposed on the basis of the passenger's line of sight. Through this, when the screen 500 is moved, the ventilation duct 100 is hidden from the passenger's line of sight by being obscured by the screen 500, so that a sense of sophistication may be realized by concealing the ventilation duct 100.

In addition, when the screen 500 is moved, the conditioned air discharged from the ventilation duct 100 is blocked and spread by the screen 500, so that the conditioned air may be gently provided to the passenger.

Meanwhile, various air conditioning modes may be implemented by controlling the ventilation duct apparatus for air conditioning described above.

To this end, a controller 600 configured to adjust a rotation position of the duct 100 and a deployment or a storage of the screen 500 by controlling the duct driving part M1 and the screen driving part M2 may further be provided.

The controller 600 is capable of controlling the air conditioner H according to the temperature required by the passenger. The controller 600 is further configured to adjust the ventilation direction of the conditioned air by controlling the duct driving part M1 and the screen driving part M2.

Such a controller 600 controls the duct driving part M1 and the screen driving part M2 for each mode desired by the user. Each mode may be a pre-stored mode and may be a mode that the user directly sets.

For example, the mode of the controller 600 may be divided into a first ventilation mode, a second ventilation mode, and a diffusing mode.

The first ventilation mode may be a mode in which the ventilation direction of the ventilation duct 100 is adjusted according to each situation, such as a setting of the passenger or an automatic setting according to the interior temperature and the external air temperature. In addition, the first ventilation mode may be performed when the mobility device performs air conditioning while the mobility device is driven.

The second ventilation mode may correspond to a relaxation mode and may be performed in a situation in which the passenger is resting. Accordingly, the second ventilation mode may be performed in a situation in which the mobility device is parked or stopped.

The diffusing mode may correspond to a relaxation mode different from the second ventilation mode. The diffusing mode may be performed according to a temperature condition. The diffusing mode may further be performed according to whether the passenger commands the diffusing mode in a situation in which the mobility device is parked or stopped. In such a diffusing mode, the conditioned air is not directly supplied to the passenger, and the conditioned air is diffused such that the temperature of the interior space is adjusted.

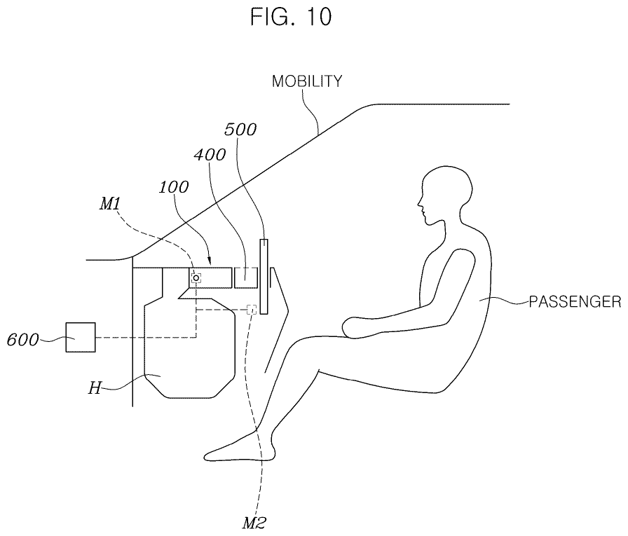

Specifically, when the air conditioner H is not used, the controller 600 controls the duct driving part M1 and the screen driving part M2 so that the ventilation duct 100 is moved downward and stored and the screen 500 is partially moved. Accordingly, as illustrated in FIG. 10, the ventilation duct 100 is not exposed to the passenger's line of sight by the screen 500.

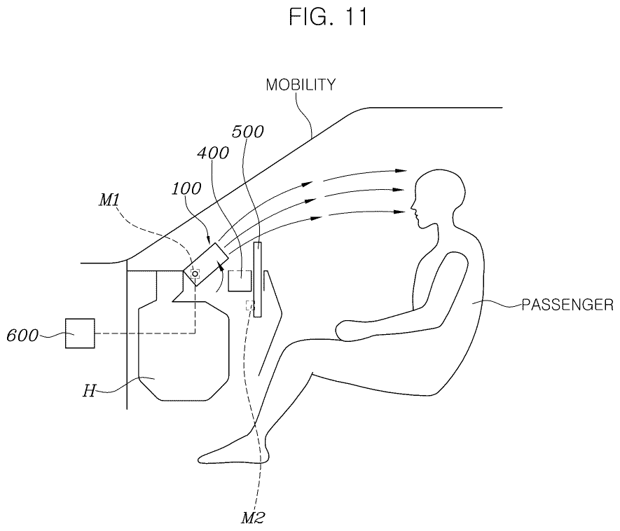

In the first ventilation mode, as illustrated in FIG. 11, the controller 600 controls the duct driving part M1 and the screen driving part M2 such that the ventilation duct 100 is rotated to a position set by the user or a preset position and the screen 500 is moved to a position lower than the outlet port 120 of the ventilation duct 100.

As a result, the ventilation duct 100 is deployed such that the ventilation duct 100 is rotated upward, so that the conditioned air discharged from the ventilation duct 100 may be moved toward the passenger. In addition, since the screen 500 is moved to the position lower than the outlet port 120 of the ventilation duct 100, the screen 500 does not block the flow of the conditioned air discharged from the ventilation duct 100. Furthermore, as the lower portion of the ventilation duct 100 is not exposed to the passenger's line of sight, deterioration of the design is prevented.

In addition, the controller 600 controls the position of the ventilation duct 100 in the vertical direction according to a seat position, a seat angle, a temperature of the conditioned air required by the passenger, or the like, so that the conditioned air may be optimally provided to the passenger.

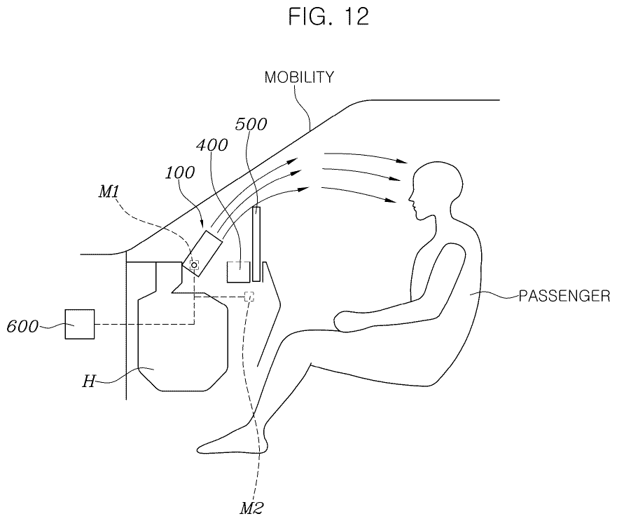

Meanwhile, in the second ventilation mode, as illustrated in FIG. 12, the controller 600 may control the duct driving part M1 and the screen driving part M2 such that the ventilation duct 100 is maximally moved upward and the screen 500 is maximally moved upward.

Here, the angle in which the ventilation duct 100 is maximally rotated upward may be set to 60° as an example, and the maximum rotation angle of the ventilation duct 100 may be set in consideration of various factors such as the interior space, the position of the passenger, or the like.

Thus, as the ventilation duct 100 is rotated maximally upward, the ventilation duct 100 discharges the conditioned air upward. Furthermore, as the screen 500 is moved maximally upward, the lower side of the ventilation duct 100 is not exposed to the passenger's line of sight. Such a second ventilation mode may be performed when the mobility device is parked, so that the temperature of the interior space may be adjusted by supplying the conditioned air to a front surface portion of the interior space.

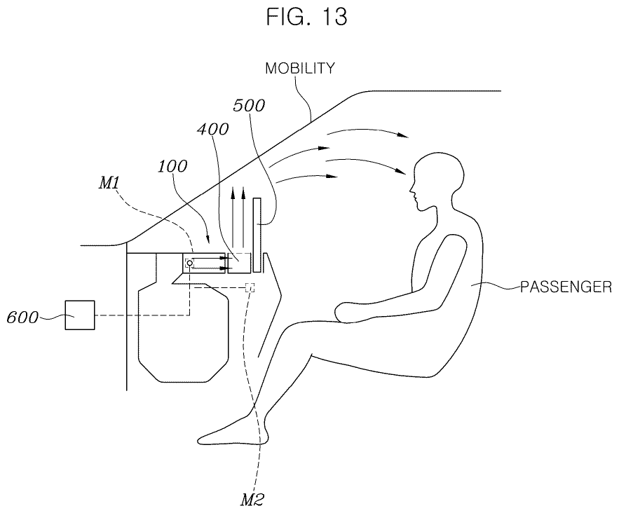

Meanwhile, in the diffusing mode, as illustrated in FIG. 13, the controller 600 may control the duct driving part M1 and the screen driving part M2 such that the ventilation duct 100 is moved to be stored so that the conditioned air is discharged through the diffusing duct 400. The controller 600 may further control the duct driving part M1 and the screen driving part M2 such that the screen 500 is moved to a preset position according to the diffusing mode.

Thus, in the diffusing mode, as the ventilation duct 100 is rotated downward and stored and the outlet port 120 of the ventilation duct 100 matches with the diffusing duct 400, the conditioned air discharged from the ventilation duct 100 is provided to the interior space through the diffusing duct 400. For example, when the ventilation duct 100 is rotated downward and is stored, the conditioned air is provided such that the conditioned air is diffused upward through the diffusing duct 400. Therefore, the conditioned air may be spread upward in the interior space.

As described above, various modes can be realized through the ventilation duct apparatus for air conditioning. The conditioned air is provided in an optimized mode according to the driving situation of the mobility device, the position and the posture of the passenger, the temperature by the passenger, or the like, thereby increasing the comfort and satisfaction of the passenger.

Although embodiments of the present disclosure have been described herein, it is understood that the present disclosure should not be limited to these embodiments. Various changes and modifications can be made by those having ordinary skill in the art within the spirit and scope of the present disclosure.

1. A ventilation duct apparatus for air conditioning, the ventilation duct apparatus comprising:
a duct comprising an inlet port to which conditioned air from an air conditioner is supplied and an outlet port to which the conditioned air is discharged;
a first direction switching unit comprising a first driving part and at least one first flap, the at least one first flap being mounted inside the duct and configured to be tilted in a side direction, wherein a tilting position of the at least one first flap is switched by the first driving part, thereby switching a flow direction of the conditioned air into the side direction; and
a second direction switching unit comprising a second driving part and at least one second flap, the at least one second flap being provided on either an upper side or a lower side of the at least one first flap or on both the upper side and the lower side of the at least one first flap, the at least one second flap further configured to be curvedly modified by the second driving part, thereby switching the flow direction of the conditioned air into a vertical direction.

2. The ventilation duct apparatus of claim 1, wherein a guide surface of the at least one first flap faces the side direction and stands upright to allow the at least one first flap to be tilted in the side direction, and wherein an upper portion and a lower portion of the at least one first flap facing the at least one second flap are formed in a concave shape.

3. The ventilation duct apparatus of claim 1, wherein:
the first driving part comprises a first actuator and a first driving shaft,
the first actuator is mounted in the duct, and
the first driving shaft extends from the first actuator to cross the duct in the side direction and is connected to the at least one first flap, so that a tilting angle of the at least one first flap is switched as the first driving shaft is rectilinearly moved in the side direction by an operation of the first actuator.

4. The ventilation duct apparatus of claim 3, wherein:
the first driving part is mounted at a side of the inlet port of the duct, and
the first driving shaft is connected to a distal end of the at least one first flap at the side of the inlet port such that the first driving shaft is capable of being rotated.

5. The ventilation duct apparatus of claim 1, wherein the duct is provided with a guide shaft, the guide shaft extending to penetrate a center portion of a guide surface of the at least one first flap.

6. The ventilation duct apparatus of claim 5, wherein:
a penetration slot through which the guide shaft passes is formed in the at least one first flap, and
the penetration slot extends from a center portion of the at least one first flap in a longitudinal direction such that the at least one first flap is tilted only by a preset maximum angle.

7. The ventilation duct apparatus of claim 1, wherein:
a first mounting part at a side of the inlet port and a second mounting part at a side of the outlet port are formed inside the duct such that the first mounting part and the second mounting part are spaced apart from each other, and
both distal ends of the at least one second flap are respectively connected to the first mounting part and the second mounting part when a guide surface of the at least one second flap is laid down to face upper and lower surfaces of the duct.

8. The ventilation duct apparatus of claim 7, wherein:
a guide slot is formed in either the first mounting part or the second mounting part,
any one of end portions of the at least one second flap is connected to the guide slot to be slid, and
another one of the end portions of the at least one second flap is fixed to a remaining one of the first mounting part or the second mounting part.

9. The ventilation duct apparatus of claim 8, wherein the guide slot extends to a length that prevents the end portions of the at least one second flap from being detached even when the at least one second flap is modified by the second driving part.

10. The ventilation duct apparatus of claim 1, wherein:
the second driving part comprises a second actuator and a second driving shaft,
the second actuator is mounted in the duct, and
the second driving shaft extends from the second actuator to cross the duct in the vertical direction and is connected to the at least one second flap, such that the at least one second flap is curvedly modified as the second driving shaft is rectilinearly moved in the vertical direction by an operation of the second actuator.

11. The ventilation duct apparatus of claim 10, wherein the second driving shaft is connected to a center portion of the at least one second flap.

12. The ventilation duct apparatus of claim 1, wherein a recessed part is formed in a portion of the duct facing a guide surface of the at least one second flap.

13. A ventilation system for air conditioning, the ventilation system comprising:
a ventilation duct configured to be rotated in a vertical direction by a duct driving part, wherein the ventilation duct includes:
an inlet port to which conditioned air is supplied and an outlet port to which the conditioned air is discharged,
a first direction switching unit including a first flap that is configured to be tilted in a side direction according to an operation of a first driving part and to switch a flow direction of the conditioned air into the side direction, and
a second direction switching unit provided on either an upper side or a lower side of the first flap or on both the upper and lower sides of the first flap and configured to switch the flow direction of the conditioned air into the vertical direction by being curvedly modified according to an operation of a second driving part; and
a diffusing duct provided to match with the outlet port of the ventilation duct when the ventilation duct is moved downward, the diffusing duct configured to switch a flow direction of the conditioned air discharged through the outlet port p of the ventilation duct and to discharge the conditioned air into a direction where the conditioned air is diffused.

14. The ventilation system of claim 13, wherein a passage part configured to be modified is provided at the inlet port of the ventilation duct, and the passage part is connected to a flow path of an air conditioner, thereby receiving the conditioned air.

15. The ventilation system of claim 13, wherein the diffusing duct comprises:
an inlet part that matches with the outlet port of the ventilation duct when the ventilation duct is moved downward,
an outlet part which is open upward and has a diffusing part, and
end portions of the diffusing duct connecting the inlet part and the outlet part to each other that are curvedly formed.

16. The ventilation system of claim 13, further comprising a screen disposed to be spaced apart from a side of the outlet port of the ventilation duct, the screen configured to be moved in the vertical direction or stored by a screen driving part.

17. The ventilation system of claim 16, wherein the ventilation duct and the screen are disposed in front of a passenger, and the screen is disposed between the ventilation duct and the passenger.

18. The ventilation system of claim 16, further comprising a controller configured to control the duct driving part and the screen driving part for each mode, thereby adjusting a rotation position of the ventilation duct and a deployment or a storage of the screen.

19. The ventilation system of claim 18, wherein, in a first ventilation mode, the controller is configured to control the duct driving part and the screen driving part such that the ventilation duct is rotated to a position set by a user or a preset position and the screen is moved to a position lower than the outlet port of the ventilation duct.

20. The ventilation system of claim 18, wherein, in a second ventilation mode, the controller is configured to control the duct driving part and the screen driving part such that the ventilation duct is moved maximally upward and the screen is moved maximally upward.

21. The ventilation system of claim 18, wherein, in a diffusing mode, the controller is configured to control the duct driving part and the screen driving part such that the ventilation duct is moved to be stored so that conditioned air is discharged through the diffusing duct and the screen is moved to a preset position according to the diffusing mode.
